(19) United States
(12) Patent Application Publication
(10) Pub. No.: US 2025/0319712 A1
(43) Pub. Date: Oct. 16, 2025

(54) RECORDING APPARATUS AND METHOD FOR CONTROLLING THE SAME

(71) Applicant: CANON KABUSHIKI KAISHA, Tokyo (JP)

(72) Inventor: TATSURO WATANABE, Tokyo (JP)

(21) Appl. No.: 19/091,584

(22) Filed: Mar. 26, 2025

(30) Foreign Application Priority Data
Apr. 11, 2024 (JP) 2024-064300

(51) Int. Cl. B41J 29/393; B41J 3/46; B41J 29/387; B41J 29/46; H02J 7/00

(52) U.S. Cl. CPC B41J 29/393; B41J 3/46; B41J 29/387; B41J 29/46; H02J 7/0042; H02J 2207/50

(57) ABSTRACT

A recording apparatus includes a first power storage unit, a second power storage unit, a connection unit configured to connect with an external power source via an insertable/removable connection unit, and a recording unit configured to perform recording on a recording medium by using the power of either one of the first and the second power storage units, wherein the recording apparatus further includes a charging unit configured to charge the first or the second power storage unit, a charging target switching unit configured to change a charging target to be charged by the charging unit, and a control unit configured to, in a state where the external power source is unconnected to the connection unit, charge the first power storage unit by using the power of the second power storage unit.

### BACKGROUND

### Field of the Disclosure

The present disclosure relates to a recording apparatus and a method for controlling the recording apparatus.

### Description of the Related Art

As a recording apparatus for performing recording by discharging ink from a head unit, there has been proposed a recording apparatus operating on power supplied from an external apparatus via a wired interface terminal.

U.S. Patent No. 2017/0334226 discusses a technique for storing power supplied from an external power source via a universal serial bus (USB) cable in a power storage unit and then executing a sequence by using the stored power.

Japanese Patent Application Laid-Open No. 2013-121207 discusses a technique for switching the charging/discharging operation between two different power storage devices included in an apparatus. This technique is intended to supplement an insufficient amount of a current supplied from an external power source with respect to a load current.

### SUMMARY

According to an aspect of the present disclosure, a recording apparatus includes a first power storage unit, a second power storage unit, a connection unit configured to connect with an external power source via an insertable/removable connection unit, and a recording unit configured to perform recording on a recording medium by using the power of either one of the first and the second power storage units, wherein the recording apparatus further includes a charging unit configured to charge the first or the second power storage unit, a charging target switching unit configured to change a charging target to be charged by the charging unit, and a control unit configured to, in a state where the external power source is unconnected to the connection unit, charge the first power storage unit by using the power of the second power storage unit.

According to another aspect of the present disclosure, a method for controlling a recording apparatus including a first power storage unit, a second power storage unit, a connection unit configured to connect with an external power source via an insertable/removable connection unit, and a recording unit configured to perform recording on a recording medium includes switching a charging target of a charging unit configured to charge the first or the second power storage unit, switching a source of power supply to the charging target between the external power source and the second power storage unit, and charging, in a state where the external power source is unconnected to the connection unit, the first power storage unit by using the power of the second power storage unit.

Further features of the present disclosure will become apparent from the following description of exemplary embodiments with reference to the attached drawings.

### BRIEF DESCRIPTION OF THE DRAWINGS

FIG. 1 is schematic view illustrating an example internal configuration of an image recording apparatus.

FIG. 2A is a block diagram illustrating a control configuration of the image recording apparatus.

FIG. 2B is a block diagram illustrating another control configuration of the image recording apparatus.

FIG. 2C is a block diagram illustrating still another control configuration of the image recording apparatus.

FIG. 2D is a block diagram illustrating still another control configuration of the image recording apparatus.

FIG. 3 is a timing chart illustrating charging and discharging of an Electric Double Layer Capacitor (EDLC) during a recording operation.

FIGS. 4A and 4B are flowcharts illustrating an example of charging/discharging processing of the image recording apparatus.

### DESCRIPTION OF THE EMBODIMENTS

The following exemplary embodiments are illustrative examples of the present disclosure described as specifically as possible to satisfy specification requirements (description requirements and implementation requirements) required by law. As described below, this naturally means that the present disclosure is not limited to the specific configurations of the following exemplary embodiments.

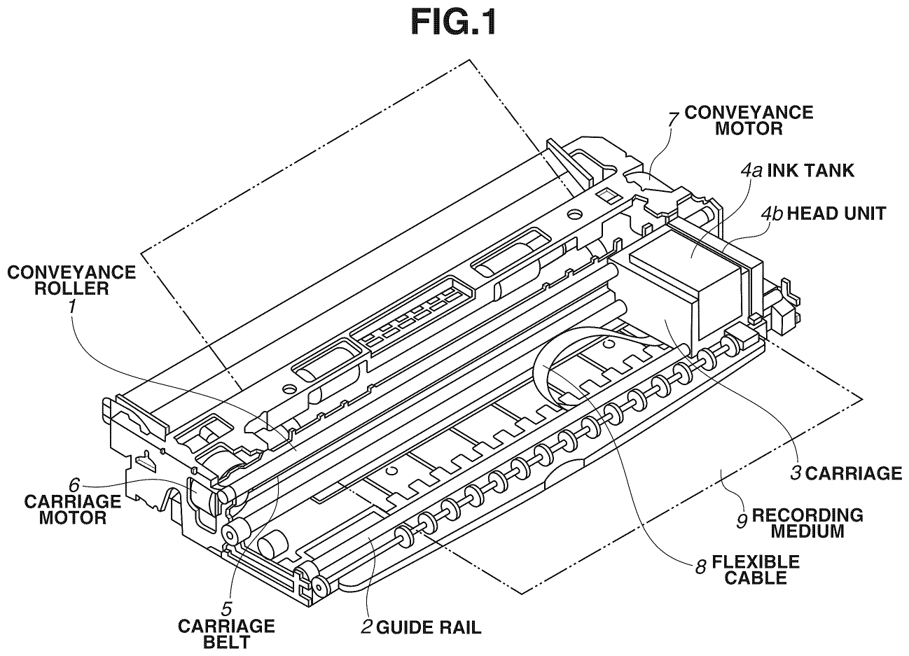

FIG. 1 is a perspective view illustrating an internal configuration of a recording apparatus (printer PR1). The printer PR1 includes a conveyance roller 1, a guide rail 2, a carriage 3, an ink tank 4a, a head unit 4b (recording unit), a carriage belt 5, a carriage motor 6, a conveyance motor 7, and a flexible cable 8. The head unit 4b mounted on the carriage 3 can be reciprocated in the longitudinal direction of the guide rail 2 along the guide rail 2. The ink discharged from the head unit 4b reaches a recording medium 9 at the platen (not illustrated) across a minute gap between the head unit 4b and the recording medium 9 to form an image thereon. The head unit 4b is supplied with a recording signal corresponding to image data via the flexible cable 8. The carriage motor 6 causes the carriage 3 to scan along the guide rail 2. The carriage belt 5 transmits the driving force of the carriage motor 6 to the carriage 3. The conveyance motor 7 connects with the conveyance roller 1 to convey the recording medium 9. The head unit 4b connects with the ink tank 4a to form a head cartridge. This head cartridge may be configured so that the head unit 4b and the ink tank 4a can be separated or separately disposed.

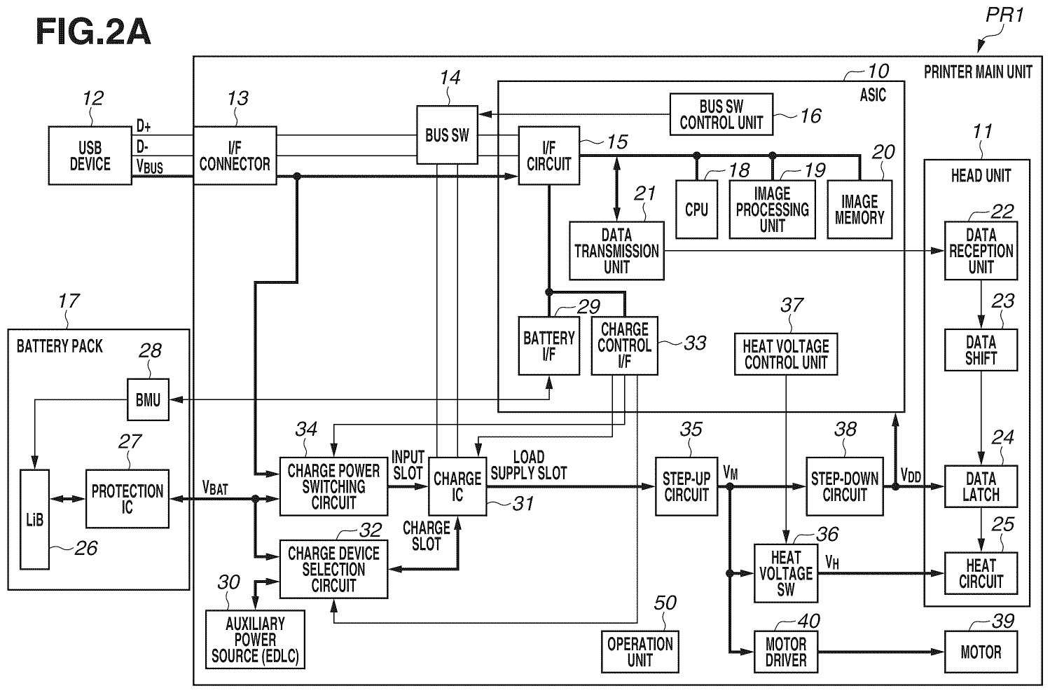

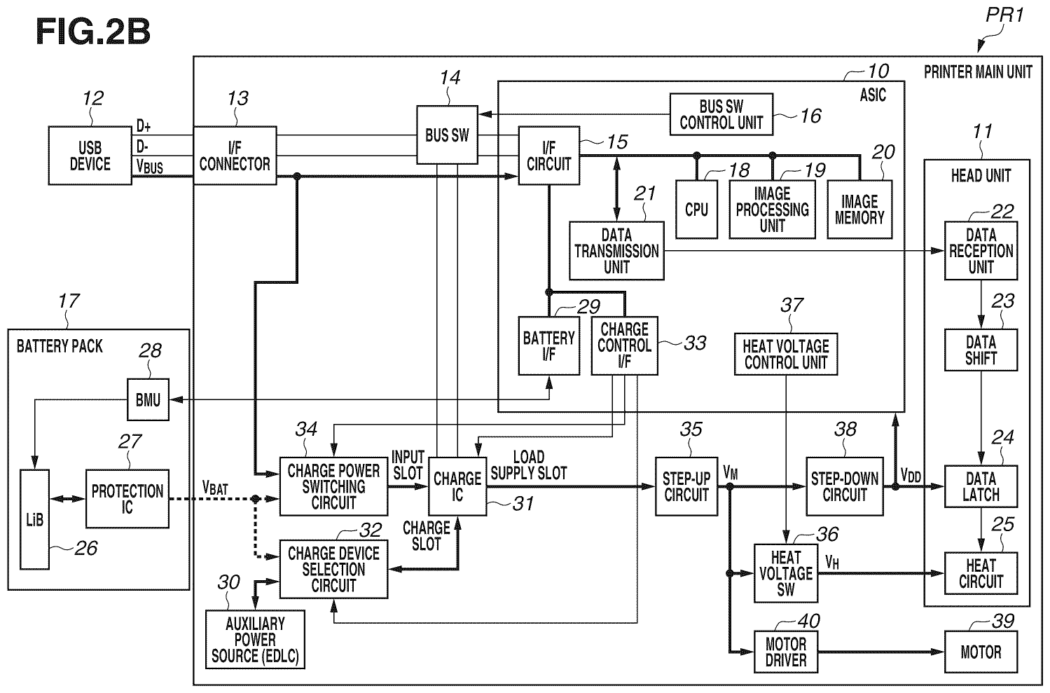

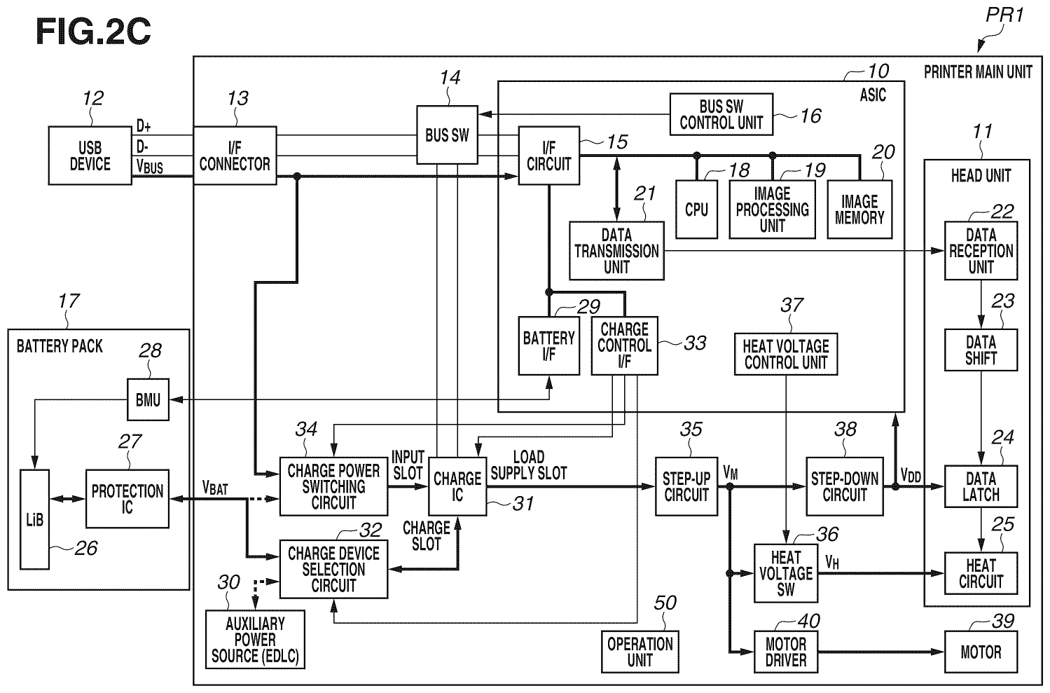

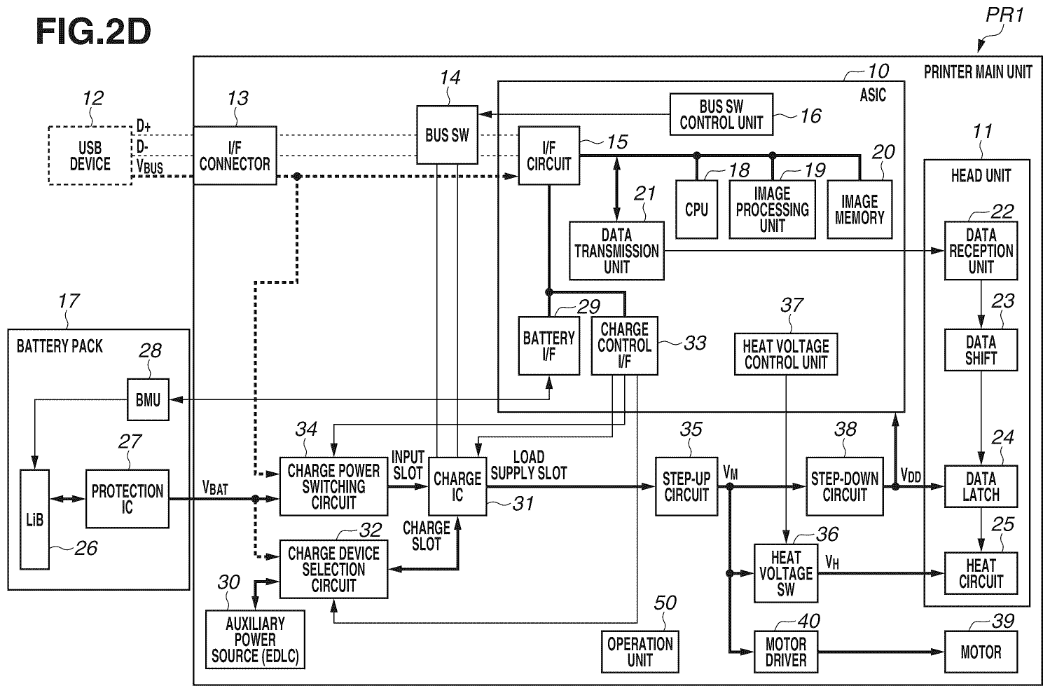

FIG. 2A is a block diagram illustrating a control configuration of the printer PR1. An application specific integrated circuit (ASIC) 10 (control unit) controls the printer PR1, and a head unit 11 discharges ink. A universal serial bus (USB) 12 is, for example, a host personal computer (PC) that allows a user to generate an image to be recorded and record the image. According to the present exemplary embodiment, a USB device 12 is described as an external power source for the printer PR1. The USB device 12 is connected with an interface (I/F) connector 13 (connection unit) of the printer PR1 via a USB cable (not illustrated) conforming to the USB standard. The USB cable is insertable into and removable from the connection unit. A control command and recording data are transmitted from the USB device 12 via the I/F connector 13 and a bus switch (bus SW) 14. The transmitted control command and recording data are received in the ASIC 10 via an interface (I/F) circuit 15. A bus SW control unit 16 controls the bus SW 14 to set the connection of the D+ and D− pins of the USB device 12 with either the ASIC 10 or a battery pack 17.

The control command received by the I/F circuit 15 is analyzed by a central processing unit (CPU) 18. The printer PR1 is controlled according to the received control command. The recording data received by the I/F circuit 15 is transmitted to an image processing unit 19, subjected to various image processing corresponding to a recording method, and stored in an image memory 20 as image-processed recording data. The stored recording data is read again at the time of recording. The image memory 20 is, for example, a data memory in the form of a random access memory (RAM).

A data transmission unit 21 transmits the image-processed recording data to the head unit 11.

When the recording data is transmitted from the data transmission unit 21 to the head unit 11, the recording data is received by a data reception unit 22 in the head unit 11. The head unit 11 includes a shift register 23 and a data latch 24. The shift register 23 converts serial data received by the data reception unit 22 into parallel data, and then the data latch 24 temporarily stores the parallel data. A heat circuit 25 receives ink discharge nozzle information and heat pulse width information indicating the heating time duration of the heater, output from the data latch 24, and drives the head unit 11 to discharge ink.

The battery pack 17, which is a power source attachable to and detachable from the printer PR1, can drive the printer PR1 with an output voltage V_{BAT} as the main power source. The battery pack 17 includes a lithium-ion battery (LiB) 26 (a power source as a second power storage unit), a protection integrated circuit (IC) 27, and a Battery Management Unit (BMU) 28. Hereinafter the LiB 26 is also simply referred to as the battery pack 17. The protection IC 27 has a function of protecting the LiB 26 from abnormal operations such as overdischarge, overcharge, and overcurrent. The BMU 28 mainly manages the remaining capacity of the LiB 26. The BMU 28 performs communication via the battery I/F 29 on the ASIC 10 to communicate information about the remaining capacity by using a command from the ASIC 10. According to the present exemplary embodiment, the BMU 28 performs communication based on the Universal Asynchronous Receiver Transmitter (UART) method. The battery pack 17 may be fixed and undetachable by the user.

The battery pack 17 outputs almost the same current as the output current of the USB device 12, enabling mobile drive with a small battery pack.

The printer PR1 operates on either an output voltage V_{BUS} of the USB device 12 or an output voltage V_{BAT} of the battery pack 17 as the main power source. The printer PR1 also includes an auxiliary power source 30 as a first power storage unit for supplementing an instantaneous printer load such as ink discharge and drive of the motor 39. According to the present exemplary embodiment, an Electric Double Layer Capacitor (hereinafter simply referred to as an EDLC) having a lower capacity and capable of supplying a higher output current than the LiB 26, is used as the auxiliary power source 30. The LiB 26 and the EDLC 30 can be charged by a charge IC 31 (charging unit), and is subjected to charge control via a charge control I/F 33 on the ASIC 10. The charge IC 31 is connected with the D+ and D− pins via the bus SW 14, and the charge current is determined according to the USB device 12, which is a current supply source, when charging the EDLC 30 and the LiB 26 by using the power from the USB device 12. According to the present exemplary embodiment, the charge IC 31 performs the determination (hereinafter referred to as BCS determination) conforming to the USB Battery Charge (USB-BC) standard. A charge device to be charged can be selected by the charge device selection circuit 32 (charging target switching unit) and is controlled via the charge control I/F 33 on the ASIC 10.

The charge device selection circuit 32 functions as an analog switch that connects a plurality of power sources to one connection target. This circuit supports a bidirectional (charging and discharging) operation. A charge power switching circuit 34 (power switching unit) switches the input power source for charging the charge device between the USB device 12 and the battery pack 17. The charge power switching circuit 34 is controlled via the charge control I/F 33 on the ASIC 10. The charge power switching circuit 34 functions as an analog switch that connects a plurality of power sources to one connection target. The charge IC 31 is provided with a load supply slot for supplying power to the load of the printer PR1. When a load power of the printer PR1 is lower than the input power from the charge power source input to the charge IC 31, the charge IC 31 diverts surplus power to charge the charge device. When the load power of the printer PR1 is higher than the input power, the charge IC 31 automatically supplies power from the charge device to supplement the insufficient power.

A step-up circuit 35 steps up the voltage output from the load supply slot of the charge IC 31. The voltage stepped up by the step-up circuit 35 is used to drive the motor 39 and the heat voltage for discharging ink by the head unit 11. A heat voltage V_{H} can be turned ON or OFF by a heat voltage SW 36 based on an instruction from a heat voltage control unit 37 on the ASIC 10. A step-down circuit 38 generates a logic power voltage V_{DD} to be used by the ASIC 10 and the head unit 11. The motor 39 is controlled via a motor driver 40.

An operation unit 50 includes a push switch for turning the power of the printer PR1 ON or OFF, a panel (notification unit) for displaying various information, and light emitting diodes (LEDs) (notification unit).

FIGS. 2B to 2D are control block diagrams illustrating different connection states of the USB device 12. FIG. 2B is a control block diagram illustrating a state where the USB device 12 is connected and the printer PR1 is not driven. The charge power switching circuit 34 is switched to select a voltage Vbus of the USB device 12 as the input power source for the charge IC 31. Meanwhile, the charge device selection circuit 32 selects the battery pack 17 as the charging target. The battery pack 17 is charged in a state where the USB device 12 is connected with the printer PR1 which is in a wait state in a non-driven state (e.g., not in the recording state but in the stop state). FIG. 2C is a control block diagram illustrating a state where the USB device 12 is connected and the printer PR1 is driven. The charge power switching circuit 34 is switched to select the voltage Vbus of the USB device 12 as the input power source for the charge IC 31. Meanwhile, the charge device selection circuit 32 selects the EDLC 30 as the charging target. When the load power of the printer PR1 is lower than the power supplied from the USB device 12, the surplus power is used to charge the EDLC 30. When the load power of the printer PR1 is higher than the power supplied from the USB device 12, power is discharged from the EDLC 30 to supplement the insufficient power to drive the printer PR1. FIG. 2D is a control block diagram illustrating a state where the USB device 12 is unconnected and the printer PR1 is driven. The charge power switching circuit 34 is switched to select a voltage Vbat of the battery pack 17 as the input power source for the charge IC 31. Meanwhile, the charge device selection circuit 32 selects the EDLC 30 as the charging target. When the load power of the printer PR1 is lower than the power supplied from the battery pack 17, the CPU 18 diverts the surplus power to charge the EDLC 30. When the load power of the printer PR1 is higher than the power supplied from the battery pack 17, power is discharged from the EDLC 30 to supplement the insufficient power to drive the printer PR1.

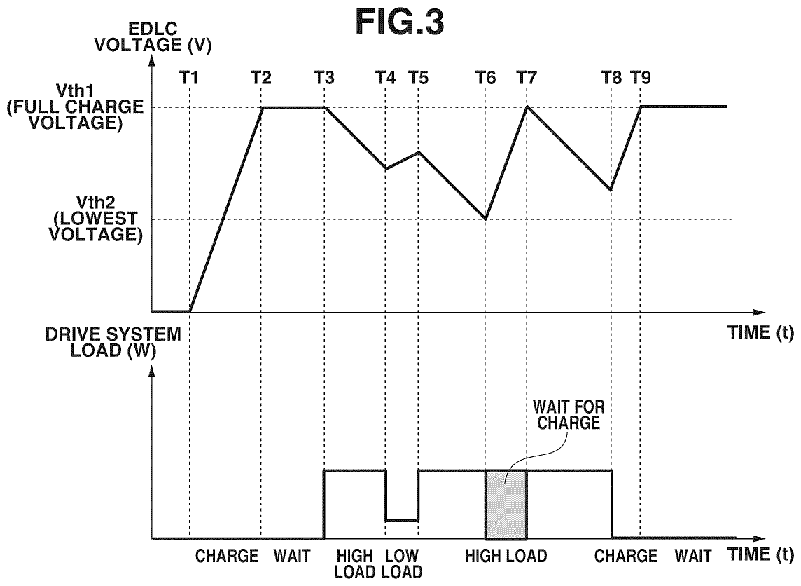

FIG. 3 is a timing chart illustrating an example of the charge control during the recording operation of the printer PR1. When the power of the printer PR1 is turned ON at time T1, the EDLC 30 is charged by the USB device 12 to a full charge condition Vth1, which is a first threshold value, at time T2, and then the control enters the wait state until time T3 at which the recording operation is started. At time T3 to T8, the charge control is performed during the recording operation. At time T3, the printer PR1 starts the recording operation, and the power consumption increases due to the drive system load. At time T3 to T4, the load increases so that the power consumption exceeds the power supplied from the USB device 12, and a voltage of the EDLC 30 gradually decreases. At time T4 to T5 during which the printer PR1 is in the wait state, the power consumption is lower than the power supplied from the USB device 12. This indicates that the surplus power is used to charge the EDLC 30 and that the voltage of the EDLC 30 gradually increases. At time T5 to T6 during which the printer PR1 performs the recording operation again, the power consumption exceeds the power supplied from the USB device 12, and the voltage of the EDLC 30 decreases to Vth2. When the voltage decreases to Vth2, the EDLC 30 waits to be charged (T6 to T7). The voltage Vth2 is a threshold value of the lowest voltage required for the end processing of the printer PR1, such as capping the discharge port of the head unit 11. When the EDLC 30 has been charged and the voltage reaches Vth1 (T7), the printer PR1 performs the recording operation again. At time T8, the printer PR1 ends the recording operation and charging of the EDLC 30 starts. When the charging is completed (T9), the printer PR1 enters a wait state. Similar charge/discharge control may be performed even in a case where power is supplied from the battery pack 17, instead of the USB device 12.

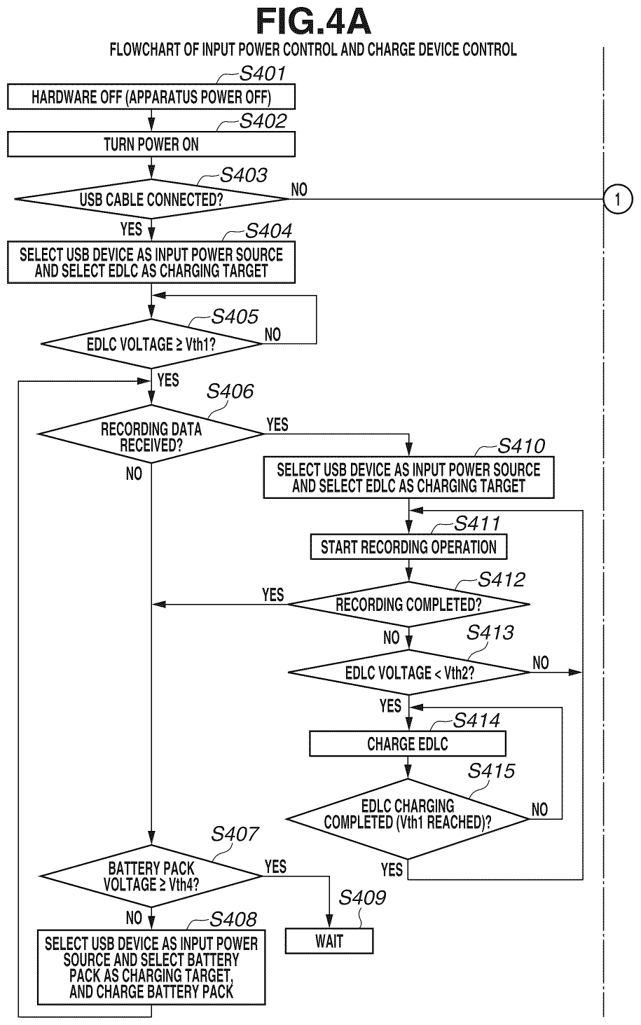

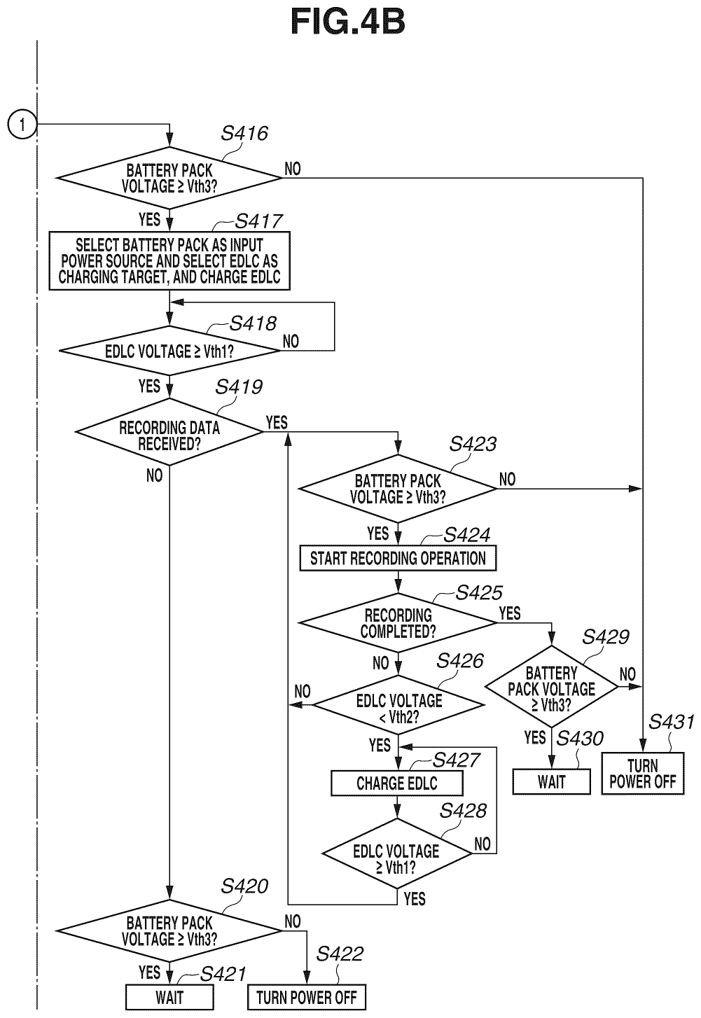

FIG. 4 is a flowchart illustrating the charge/discharge control during the recording operation. Firstly, a processing flow in a case where the USB cable is connected will be described. In step S402, the user turns the power of the printer PR1 ON (power is OFF in step S401). In step S403, the CPU 18 determines whether the USB cable is connected. If the USB cable is connected (YES in step S403), the processing proceeds to step S404. In step S404, the charge power switching circuit 34 switches the input port of the charge IC 31 to connect to the USB device 12 as the power source, and the charge device selection circuit 32 selects the EDLC 30 as the charging target, and then the EDLC 30 is charged.

In step S405, the CPU 18 determines whether the voltage of the EDLC 30 is lower than the threshold value Vth1 (first threshold value).

When the EDLC 30 has been charged, i.e., when Vth1 is reached (YES in step S405), the processing proceeds to step S406. In step S406, the CPU 18 determines whether recording data is received. If the recording data is not received (NO in step S406), the processing proceeds to step S407. In step S407, the CPU 18 determines whether the battery pack 17 has been fully charged. In this case, the CPU 18 determines whether a voltage of the LiB 26 is lower than a threshold value Vth4, which is higher than Vth3. If the battery pack 17 has not been fully charged, i.e., if the voltage is lower than Vth4 (NO in step S407), the processing proceeds to step S408. In step S408, the charge power switching circuit 34 switches the input port of the charge IC 31 to be powered by the USB device 12 as the power source, and the charge device selection circuit 32 selects the battery pack 17 as the charging target, and charging of the battery pack 17 is started. While the battery pack 17 is being charged, the CPU 18 keeps checking whether the recording data is received in step S406. When the battery pack 17 has been fully charged, i.e., when the voltage is equal to or higher than Vth4 (YES in step S407), the processing proceeds to step S409. In step S409, the printer PR1 waits until the recording data is received in step S406. If the recording data is received (YES in step S406), the processing proceeds to step S410. In step S410, the charge power switching circuit 34 is switched to select the input port of the charge IC 31 as the power source from the USB device 12, and the charge device selection circuit 32 selects the EDLC 30 as the charging target. In step S411, the recording operation is started. While recording, in step S412, the CPU 18 determines whether the recording operation is completed. If the recording operation is completed (YES in step S412), the processing proceeds to step S407. If the recording operation is not completed (NO in step S412), the processing proceeds to step S413. In step S413, the CPU 18 determines whether the voltage of the EDLC 30 is lower than Vth2 (second threshold value). If the voltage of the EDLC 30 is not lower than Vth2, i.e., if the voltage is equal to or higher than Vth2 (NO in step S413), the processing returns to step S411. In step S411, the CPU 18 continues the recording operation. If the voltage of the EDLC 30 decreases to Vth2, i.e., if the voltage is lower than Vth2 (YES in step S413), the processing proceeds to step S414. In step S414, the CPU 18 stops the recording operation, moves the head unit 11 to a predetermined position, and then charges the EDLC 30. When the voltage of the EDLC 30 reaches Vth1, i.e., when charging of the EDLC 30 has been completed (YES in step S415), the processing returns to step S411. In step S411, the recording operation is restarted. The predetermined position, for example, refers to the position where the discharge port of the head unit 11 is capped. Although the EDLC 30 is charged until the voltage of the EDLC 30 reaches Vth1 in step S415, the threshold value may be changed according to the power required to record the remaining recording data.

A processing flow in a case where the USB cable is unconnected will be described below. In a case where the USB cable is unconnected (NO in step S403), the processing proceeds to step S416. In step S416, the CPU 18 determines the remaining capacity of the battery pack 17. If a voltage of the battery pack 17 is lower than a predetermined voltage Vth3 (NO in step S416), the CPU 18 notifies the user that the power of the battery pack 17 is insufficient and that the recording operation is disabled, via the operation unit 50 of the printer PR1. In step S431, the power is turned OFF. The notification is issued during a certain period of time before turning the power OFF. If the voltage of the battery pack 17 is the predetermined voltage Vth3 or more, corresponding to, for example, the remaining capacity sufficient for recording data on one sheet of recording medium (YES in step S416), the processing proceeds to step S417. In step S417, the charge power switching circuit 34 is switched to select the battery pack 17 as the input power source, the charge device selection circuit 32 selects the EDLC 30 as the charging target, and charging of the EDLC 30 is started. When the voltage of the EDLC 30 reaches Vth1, i.e., when the charging is completed (YES in step S418), the processing proceeds to step S419. In step S419, the CPU 18 determines whether the recording data is received. If the recording data is not received (NO in step S419), the processing proceeds to step S420. In step S420, the remaining capacity is determined based on whether the voltage of the battery pack 17 is equal to or higher than Vth3. If the voltage of the battery pack 17 is equal to or higher than Vth3 (YES in step S420), the processing proceeds to step S421. In step S421, the printer PR1 waits for the reception of the recording data. If the voltage is lower than Vth3 (NO in step S420), the CPU 18 notifies the user that the power of the battery pack 17 is insufficient and that the recording operation is disabled, via the operation unit 50 of the printer PR1. After the notification, the processing proceeds to step S422. In step S422, the power is turned OFF. If the recording data is received (YES in step S419), the processing proceeds to step S423. In step S423, the CPU 18 determines the remaining capacity of the battery pack 17. If the voltage of the battery pack 17 is equal to or higher than Vth3 (YES in step S423), the processing proceeds to step S424. In step S424, the recording operation is started. In step S425, the CPU 18 determines whether the recording operation is completed. If the recording operation is not completed (NO in step S425), the processing proceeds to step S426. In step S426, the CPU 18 determines whether the voltage of the EDLC 30 is lower than Vth2. If the voltage of the EDLC 30 is equal to or higher than Vth2 (NO in step S426), the processing returns to step S423. If the voltage of the EDLC 30 is lower than Vth2 (YES in step S426), the CPU 18 stops the recording operation and moves the head unit 11 to a predetermined position. Then, the processing proceeds to step S427. In step S427, the EDLC 30 is charged. When the voltage of the EDLC 30 is equal to or higher than Vth1, i.e., when the charging is completed (YES in step S428), the processing returns to step S423.

If the recording operation is completed (YES in step S425), the processing proceeds to step S429. In step S429, the CPU 18 determines the remaining capacity of the battery pack 17. If the voltage of the battery pack 17 is equal to or higher than Vth3 (YES in step S429), the processing proceeds to step S430. In step S430, the printer PR1 waits for the reception of the recording data. If the voltage is lower than Vth3 (NO in step S429), the CPU 18 notifies the user that the power of the battery pack 17 is insufficient and that the recording operation is disabled, via the operation unit 50 of the printer PR1. Then, the processing proceeds to step S431. In step S431, the power is turned OFF. Similarly, if the remaining capacity of the battery pack 17 is insufficient (NO in step S423), the CPU 18 notifies the user of the insufficient remaining capacity of the battery pack 17. Then, the processing proceeds to step S431. In step S431, the power is turned OFF.

According to the above-described configuration, in a case where the USB device 12 is connected via the USB cable, the CPU 18 selects the USB device 12 as the input power source, charges the charging target (the EDLC 30 and the battery pack 17) while switching between them, and drives the printer PR1. Meanwhile, in a case where the USB cable is unconnected or disconnected and the power from the USB device 12 is lost, the CPU 18 enables mobile drive by using the battery pack 17 as the input power source and using the EDLC 30 as an auxiliary power source. The current output from the battery pack 17 is as low as the output current of the USB device 12, enabling mobile drive with a small battery pack. The circuit simplification can be achieved by charging the two different power storage devices with one charge circuit.

### Other Exemplary Embodiments

Although a host PC is used as an example of the USB device 12, the present disclosure is not limited thereto. For example, the USB device 12 may be a portable communication terminal such as a smartphone, a USB charger, and a mobile LiB. In a case where the printer PR1 is connected with a non-communication terminal such as a USB charger and a mobile battery, the terminal is separately connected with the printer PR1 via a communication terminal for wirelessly transmitting recording data.

Control commands and recording data may be transmitted from the USB device 12 via wireless communication.

FIG. 3 illustrates voltage change of the EDLC 30 in response to the excessive or insufficient power from the USB device 12 caused by load variations. A similar operation will result in response to the power from the battery pack 17.

Referring to FIG. 3, the insufficient power from the EDLC 30 with respect to the load power of the printer PR1 may be supplemented by the power supplied from the USB device 12 or the battery pack 17 to the load.

An example of the recording operation has been described above. The charge/discharge control in response to the load power during the read operation of an automatic document feeder (ADF) or a flat-bed reading apparatus is applicable.

According to FIG. 4, the full charge is determined based on the voltage threshold value Vth1 of the EDLC 30. However, instead of determining the full charge, the threshold value may be set for the power consumption required for recording data on one sheet of recording medium, or the threshold value may be variably set.

In step S422 or S431 in FIG. 4, the CPU 18 may issue a notification to prompt the user to connect the USB cable.

The notification before entering the power OFF state may be made by lighting up a light emitting diode (LED) instead of displaying the notification on the operation unit 50.

The content of the notification to be made before entering the power OFF state may be transmitted to the USB device 12 to be displayed on the USB device 12.

After the processing proceeds to step S417 and before step S418, when the recording data and instructions for starting the recording operation are received, the CPU 18 may interrupt the charge control to execute step S423.

In addition, Vth1 and Vth2 are used as examples of threshold values for determining whether to charge the EDLC 30 and Vth3 and Vth4 are used as examples of threshold values for determining whether to charge the battery pack 17. However, only one threshold value may be used instead of two threshold values for each charge device.

In step S428 in FIG. 4, the CPU 18 determines whether the voltage of the EDLC 30 has been charged to equal to or higher than Vth1. However, a threshold value (lower than Vth1 and higher than Vth2) for the power required to record the remaining data may be set.

The disclosure of the above-described exemplary embodiment includes the following configurations and methods.

### Configuration 1

A recording apparatus includes a first power storage unit, a second power storage unit, a connection unit configured to connect with an external power source via an insertable/removable connection unit, and a recording unit configured to perform recording on a recording medium. The recording apparatus further includes a charging unit configured to charge the first or the second power storage unit, a charging target switching unit configured to change a charging target to be charged by the charging unit, and a control unit configured to, in a state where the external power source is unconnected to the connection unit, charge the first power storage unit by using the power of the second power storage unit.

### Configuration 2

The recording apparatus according to configuration 1, wherein, if a voltage of the first power storage unit is lower than a first threshold value, the control unit charges the first power storage unit by using the power of the second power storage unit.

### Configuration 3

The recording apparatus according to configuration 1 or 2, wherein, in a state where the external power source is unconnected to the connection unit, the recording apparatus performs recording by using the power of at least the first power storage unit.

### Configuration 4

The recording apparatus according to configuration 3, wherein, in a state where the external power source is unconnected to the connection unit and where the voltage of the first power storage unit is lower than a second threshold value lower than the first threshold value during recording by the recording unit, the control unit interrupts recording and charges the first power storage unit by using the power of the second power storage unit.

### Configuration 5

The recording apparatus according to any one of configurations 1 to 4, wherein, in a state where the external power is unconnected to the connection unit and where a voltage of the second power storage unit is lower than a third threshold value, the control unit turns OFF the power of the recording apparatus.

### Configuration 6

The recording apparatus according to configuration 5, further including a notification unit, wherein the control unit notifies, via the notification unit, before turning OFF the power of the recording apparatus, a user of a content that prompts the user to connect the external power source.

### Configuration 7

The recording apparatus according to configuration 5 or 6, further including a notification unit, wherein the control unit notifies, via the notification unit, before turning OFF the power of the recording apparatus, a user of an insufficient power via a display unit.

### Configuration 8

The recording apparatus according to any one of configurations 1 to 7, wherein, in a state where the external power source is connected and where the voltage of the second power storage unit is lower than a fourth threshold value, the control unit charges the second power storage unit by using the external power source.

### Configuration 9

The recording apparatus according to any one of configurations 1 to 8, wherein, in a state where the external power is connected to the connection unit, the control unit charges the first power storage unit with surplus power amount of the power supplied from the external power source with respect to the power consumption during recording by the recording unit.

### Configuration 10

The recording apparatus according to any one of configurations 1 to 9, wherein the connection unit is a universal serial bus (USB) cable conforming to the USB standard.

### Configuration 11

The recording apparatus according to any one of configurations 1 to 10, wherein the first power storage unit is an electric double layer capacitor.

### Configuration 12

The recording apparatus according to any one of configurations 1 to 11, wherein the second power storage unit is a lithium-ion battery.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-064300, filed Apr. 11, 2024, which is hereby incorporated by reference herein in its entirety.

What is claimed is:

1. A recording apparatus comprising:
a first power storage unit;
a second power storage unit;
a connection unit configured to connect with an external power source via an insertable/removable connection unit; and
a recording unit configured to perform recording on a recording medium by using the power of either one of the first and the second power storage units;
wherein the recording apparatus further comprises:
a charging unit configured to charge the first or the second power storage unit;
a charging target switching unit configured to change a charging target to be charged by the charging unit; and
a control unit configured to, in a state where the external power source is unconnected to the connection unit, charge the first power storage unit by using the power of the second power storage unit.

2. The recording apparatus according to claim 1, wherein, in a case where a voltage of the first power storage unit is lower than a first threshold value, the control unit charges the first power storage unit by using the power of the second power storage unit.

3. The recording apparatus according to claim 1, wherein, in a state where the external power source is unconnected to the connection unit, the recording apparatus performs recording by using the power of at least the first power storage unit.

4. The recording apparatus according to claim 3, wherein, in a state where the external power source is unconnected to the connection unit and where a voltage of the first power storage unit is lower than a second threshold value lower than a first threshold value during recording by the recording unit, a control unit interrupts recording and charges the first power storage unit by using the power of the second power storage unit.

5. The recording apparatus according to claim 1, wherein, in a state where the external power is unconnected to the connection unit and where a voltage of the second power storage unit is lower than a third threshold value, the control unit turns OFF the power of the recording apparatus.

6. The recording apparatus according to claim 5, further comprising a notification unit, wherein the control unit notifies, via the notification unit, before turning OFF the power of the recording apparatus, a user of a content that prompts the user to connect the external power source.

7. The recording apparatus according to claim 6, further comprising a notification unit, wherein the control unit notifies before turning the power OFF of the recording apparatus, via the notification unit, the user of insufficient power via a display unit.

8. The recording apparatus according to claim 1, wherein, in a state where the external power source is connected and where a voltage of the second power storage unit is lower than a fourth threshold value, the control unit charges the second power storage unit by using the external power source.

9. The recording apparatus according to claim 1, wherein, in a state where the external power is connected to the connection unit, the control unit charges the first power storage unit with surplus power of the power supplied from the external power source with respect to the power consumption during recording by the recording unit.

10. The recording apparatus according to claim 1, wherein the connection unit is a universal serial bus (USB) cable conforming to a USB standard.

11. The recording apparatus according to claim 1, wherein the first power storage unit is an electric double layer capacitor.

12. The recording apparatus according to claim 1, wherein the second power storage unit is a lithium-ion battery.

13. A method for controlling a recording apparatus comprising a first power storage unit, a second power storage unit, a connection unit configured to connect with an external power source via an insertable/removable connection unit, and a recording unit configured to perform recording on a recording medium, the method comprising:
switching a charging target of a charging unit configured to charge the first or the second power storage unit;
switching a source of power supply to the charging target between the external power source and the second power storage unit; and
charging, in a state where the external power source is unconnected to the connection unit, the first power storage unit by using the power of the second power storage unit.
